(19) United States
(12) Patent Application Publication
(10) Pub. No.: US 2012/0230830 A1
(43) Pub. Date: Sep. 13, 2012

(54) ARRANGEMENT TO IMPROVE THE SURFACE OF A WIND TURBINE BLADE

(76) Inventors: Soeren Oemann LIND, Naestved (DK); Jason STEGE, Brande (DK)

(21) Appl. No.: 13/413,071

(22) Filed: Mar. 6, 2012

(30) Foreign Application Priority Data
Mar. 11, 2011 (EP) EP11157898

(51) Int. Cl. F03D 11/00

(52) U.S. Cl. 416/223 R

(57) ABSTRACT

An arrangement to improve a surface of a wind turbine blade is proposed. A plastic tape is arranged at a specific location of the blade to reinforce the blade surface there. The plastic tape shows a sandwich structure with at least two layers. The plastic tape has a first layer, which has a carbon fiber. The carbon fiber is used for reinforcement purposes of the plastic tape. The plastic tape has a second layer on a first side of the plastic tape, which is connected with the first layer. The second layer has a pure thermoplastic fluoropolymer.

### CROSS REFERENCE TO RELATED APPLICATIONS

This application claims priority of European Patent Office application No. 11157898.5 EP filed Mar. 11, 2011, which is incorporated by reference herein in its entirety.

### FIELD OF INVENTION

The invention relates to an arrangement to improve the surface of a wind turbine blade.

### BACKGROUND OF INVENTION

Offshore wind turbines and wind turbines, which are located at sites with a cold climate, needs to be protected against influences from the ambient, like ice for example, and even needs to be protected against erosion.

Especially the blades of the wind turbine need to be protected against icing. Otherwise the aerodynamic characteristics of the blades are reduced significantly and the output-power of the wind turbine is reduced.

It is known to heat the blade(s) for de-icing. This can be done by an electrical power source and by connected heating-wires, which are integrated into the blade-surface for example. Even hot or warm air may be used for de-icing. The air is brought into cavities of the blade for example and may be generated by help of wind-turbine components.

Especially the leading edge of the blade is prone to erosion, thus the surface of the blade is harmed step by step over the live-time of the wind turbine. A harmed blade surface allows ice to grow and expand there significantly.

The erosion of the blade surface is mainly caused by particles of dirt, which are blown by the wind with high velocity and which thus attack the turning blades significantly.

The erosion of the blade surface is also caused by bird-strikes, bat-strikes, frost, salt (at offshore sites), rain, insects and even by long-term loads acting on the blade.

Long-term loads may lead to hair-line cracks, which are points of attack for salt and/or ice, etc.

Document U.S. 2008/0181775 A1 discloses an improved blade in view to erosion, lightning and icing. The leading edge of the blade includes a frontal surface and an erosion shield. The shield is positioned externally at the frontal surface of the blade. A heat generating element is positioned between the shield and the frontal surface for its fixation during the blade-manufacturing-process. This solution is complicated and is even expensive.

### SUMMARY OF INVENTION

It is therefore the aim of the present invention, to provide an arrangement to improve the surface of a wind turbine blade to avoid erosion there.

This aim is reached by the features of the independent claims. Preferred configurations of the invention are object of the dependent claims.

According to the invention a special designed plastic tape is placed at specific locations of the blade-surface.

The specific locations are known to be difficult in view to erosion and thus needs to be reinforced to withstand ambient influences in a better way.

In a preferred configuration the plastic tape is placed along the leading edge of the blade as this area is known to be challenged by erosion.

The plastic tape invented comprises carbon fibers, which are used for reinforcement purposes of the tape.

The carbon fibers are used as carrier for further components of the plastic tape. Thus the carrier forms a first layer within a tape-sandwich structure.

In a preferred configuration the first layer or carrier layer comprises a thermoplastic material additionally. The thermoplastic material may be made of PTFE, PVDF, PP or PET. The thermoplastic material may be used to connect and/or to guide and/or to support the carbon fibers.

The plastic tape comprises on a first side a second layer, which is connected with the carrier-layer or first layer.

The second layer comprises a so called “Polyvinylidene Fluoride, PVDF” preferable.

The “Polyvinylidene Fluoride, PVDF” are highly non-reactive and pure thermoplastic fluoropolymer. Thus even other pure thermoplastic fluoropolymer might be used as second layer.

In a preferred configuration the plastic tape comprises a third layer on a second side of the tape. The third layer is connected with the carrier-layer or first layer and is arranged opposite to the second layer.

Thus the second side of the tape is opposite to the first side of the tape.

The second side of the plastic tape is prepared to be connected with the blade to improve the blade surface.

This connection may be established by help of the additional third layer. The third layer is preferably connected with the blade by an adhesive applied. Due to the polyester or polyurethane the third layer is best suited for the adhesive-based connection.

It is also possible that the first layer or carrier layer is prepared to be connected with the blade surface by an adhesive applied. In this case the sandwich structure shows only two layers: the carrier-layer and the second layer, while the second layer faces to the ambient as blade-surface later.

In a preferred configuration the adhesive is a liquid adhesive.

As described above the plastic tape shows a sandwich structure.

The plastic tape is preferably made of three layers:
the PVDF-layer or second layer, which foul's a top layer and is aligned to the ambient, acting as blade-surface,
the carrier-layer or first layer, which comprises the carbon fibers for reinforcement purposes, and
the third layer, which comprises polyester or polyurethane as bottom layer of the tape.

The plastic tape may even be made of two layers:
the PVDF-layer or second layer, which forms a top layer and is aligned to the ambient, acting as blade-surface, and
the carrier-layer or first layer, which comprises the carbon fibers for reinforcement purposes.

Both alternatives may be preferably connected by a liquid adhesive to the blade.

Pure thermoplastic fluoropolymer like PVDF show a low surface tension and are thus extremely hard. Heat and pressure are used to connect the thermoplastic fluoropolymer material with the carbon fibers preferably.

In a preferred configuration the plastic tape is arranged within the mould to become an integrated part of the blade-surface.

The mould is preferably used within a “Vacuum Assisted Resin Transfer Mould, VARTM”-process. Thus the tape is arranged inside the mould before a matrix material like resin, etc., is applied. The tape is arranged within the mould before the blade is casted or manufactured.

This procedure is quite simple and needs nearly no additional time for the working-personnel. Thus its positioning is quite cheap in view to the prior art.

The tape “grinds” or smoothes the surface of the casted blade. Thus less time is needed for finishing-work and repair-work after the blade-casting-process is finished.

The integrated plastic tape especially improves the blade surface in view to icing, as the resulting blade-surface is quite smooth. Thus the “grow up” of ice is reduced or even avoided at locations where the tape is arranged.

The layers of the plastic tape are preferably made by the help of a “rolling system”.

For example the first layer or carrier layer comprises a thermoplastic material, shaped as a plastic tape preferably.

The thermoplastic material may be made of PTFE, PVDF, PP or PET.

The thermoplastic material is heated close to its melting point. Next carbon fibers are pressed halfway into the heated thermoplastic material by help of rollers.

Thus the plastic material and the carbon fibers build up the first layer or carrier-layer preferably.

The other half-part of carbon fibers projects from the surface thus this part may be used to be connected with the pure thermoplastic fluoropolymer applied.

It is even possible to use a resin-based system to build up the layered plastic tape, for example a pultrusion-system. The carbon fiber is dipped in resin and is passed through rollers to a template continuously while the resin cures.

It is even possible to attach the plastic tape towards the blade afterwards. After the reinforced plastic tape is made it can be attached to the blade surface using a pressure sensitive adhesive or a traditional adhesive for example. Even various types of “hot melt adhesives” are possible for this purpose.

The plastic tape with the carbon fiber show a higher melting point in comparison to “hot melt adhesives” used. This allows the tape to be heated (externally or by a current being applied to the carbon fiber) without damaging the material until a usable temperature for the adhesive is reached.

### BRIEF DESCRIPTION OF THE DRAWINGS

The invention is shown in more detail by help of figures. The figures are only examples of preferred configurations and do not limit the scope of the invention claimed.

FIG. 1 shows a blade surface with a first tape according to the invention and in a cross-sectional view,

FIG. 2 shows a blade surface with a second tape according to the invention and in a cross-sectional view, and

FIG. 3 shows a preferred position of the tape on a wind turbine blade.

### DETAILED DESCRIPTION OF INVENTION

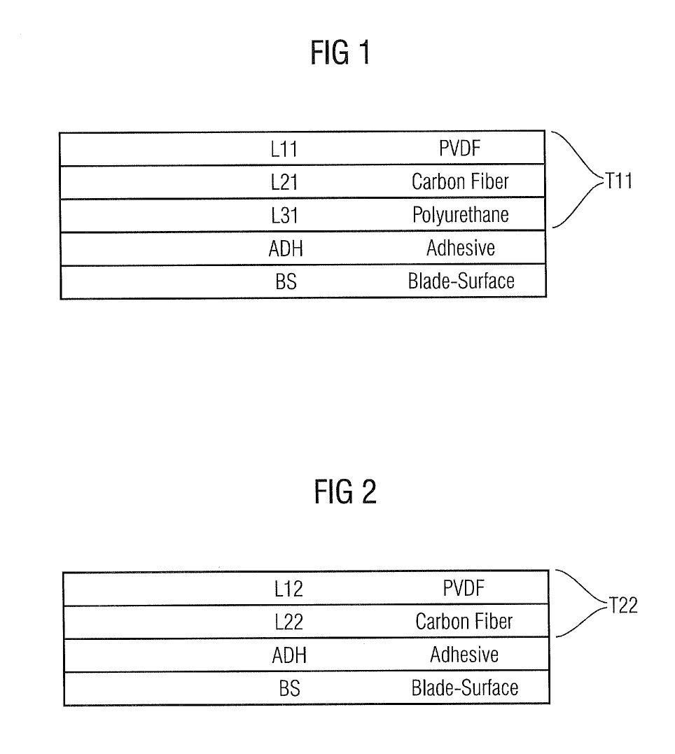

FIG. 1 shows a blade surface BS with a first tape T11 according to the invention.

The tape T11 shows a sandwich-structure and comprises three layers L11, L21, L31.

The layer L11 comprises PVDF as described above. Thus the layer Lit is part of a first side of the tape T11.

The layer L11 is connected with a carrier-layer L21. The carrier-layer L21 comprises carbon fibers for reinforcement purposes.

The carrier layer L21 is connected with a layer L31. The layer L31 comprises Polyurethan. Thus the layer L21 is part of a second side of the tape T11, which is opposite to the first side.

The tape T11 is connected with the blade surface BS by an adhesive ADH, which is applied between the tape T11 and the blade surface BS.

FIG. 2 shows a blade surface BS with a second tape T22 according to the invention.

The tape T22 comprises only two layers L12 and L22. The top layer L12 comprises PVDF as described above.

The top layer L12 is connected with a carrier-layer L22. The carrier layer L22 comprises carbon fibers for reinforcement purposes.

The tape T22 is connected with the blade surface BS by an adhesive ADH, which is applied between the tape T22 and the blade surface BS.

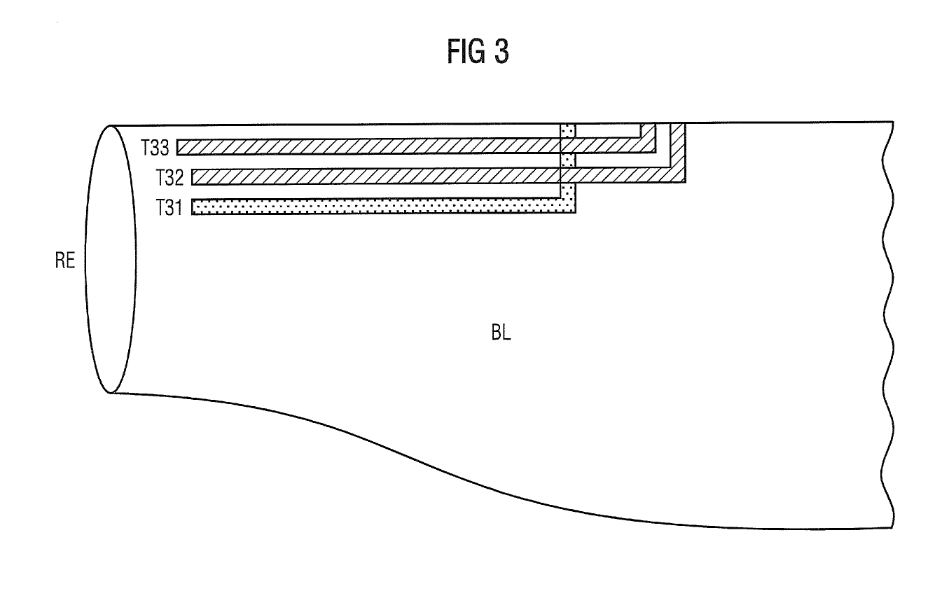

FIG. 3 shows a preferred position of tapes invented close to a root-end RE of a blade BL.

The three tapes T31, T32 and T33 show the sandwich-structure according to the invention.

The tapes T31, T32 and T33 are connected with the blade BL and thus are aligned to the ambient of the blade acting as improved blade-surface there.

For best practice the tapes T31, T32 and T33 cross each other at certain points, but they are not connected among each other at those points. Thus the tape T31 is arranged below the tapes T32 and T33 without “short-circuit” with them.

1. An arrangement to improve a surface of a wind turbine blade, comprising:
a plastic tape arranged at a specific location of the blade to reinforce a blade surface at the specific location,
wherein the plastic tape comprises a sandwich structure with at least two layers comprising:
a first layer comprising a carbon fiber to reinforce the plastic tape, and
a second layer comprising a pure thermoplastic fluoropolymer, wherein the second layer is arranged on a first side of the plastic tape and is connected with the first layer, wherein the first side of the plastic tape is aligned to an ambient of the blade.

2. The arrangement according to claim 1, wherein the second layer comprises Polyvinylidene Fluoride.

3. The arrangement according to claim 1, wherein the first layer is connected with the blade to improve the blade surface.

4. The arrangement according to claim 3, wherein the connection is an adhesive.

5. The arrangement according to claim 4, wherein the adhesive is a liquid adhesive.

6. The arrangement according to claim 1,
wherein the plastic tape further comprises a third layer,
wherein the third layer is arranged on a second side of the plastic tape and is connected with the first layer, and
wherein the second side of the plastic tape is opposite to the first side of the plastic tape.

7. The arrangement according to claim 6, wherein the third layer is connected with the blade to improve the blade surface.

8. The arrangement according to claim 7, wherein the connection is an adhesive.

9. The arrangement according to claim 8, wherein the adhesive is a liquid adhesive.

10. The arrangement according to claim 1, wherein the plastic tape is arranged within a mould to become an integrated part of the blade surface.

11. The arrangement according to claim 10, wherein the mould is prepared by a vacuum assisted resin transfer mould process.

12. The arrangement according to claim 10, wherein the plastic tape is arranged inside the mould before a matrix material is applied to cast the blade.

13. The arrangement according to claim 1, wherein the first layer and the second layer are connected by applied heat and/or pressure.

14. The arrangement according to claim 1, wherein the plastic tape is arranged at the specific location of the blade where an ambient influence leads to erosion.

15. The arrangement according to claim 1, wherein the plastic tape is arranged close to and/or along a surface of a leading edge of the blade.
